(19) United States
(12) Patent Application Publication
(10) Pub. No.: US 2022/0237482 A1
(43) Pub. Date: Jul. 28, 2022

(54) FEATURE RANDOMIZATION FOR SECURING MACHINE LEARNING MODELS

(71) Applicant: Intuit Inc., Mountain View, CA (US)

(72) Inventors: Aviv Ben Arie, Ramat Gan (IL); Liat Ben Porat Roda, Tel Aviv (IL); Liran Dreval, Tel Aviv (IL)

(73) Assignee: Intuit Inc., Mountain View, CA (US)

(21) Appl. No.: 17/159,463

(22) Filed: Jan. 27, 2021

(51) Int. Cl. G06N 5/04; G06N 20/00

(52) U.S. Cl. CPC G06N 5/04; G06N 20/00

(57) ABSTRACT

Feature randomization for securing machine learning models includes receiving an event, and altering, responsive to receiving the event, a threshold pseudo-randomly to generate an altered threshold value. Feature randomization further includes applying the altered threshold value to a threshold-dependent feature to generate an altered threshold-dependent feature value. The altered threshold-dependent feature value determined at least in part from the event. Feature randomization further includes executing a machine learning model, on the event and the altered threshold-dependent feature value, to generate a predicted event type for the event.

### BACKGROUND

Machine learning models are one form of automated cybersecurity systems used to protect computer hardware and software. However, cyber criminals develop techniques for circumventing existing cybersecurity systems, including machine learning models. Thus, improvements to securing automated cybersecurity systems are sought.

### SUMMARY

In general, in one aspect, one or more embodiments relate to a method that includes receiving an event, and altering, responsive to receiving the event, a threshold pseudo-randomly to generate an altered threshold value. The method further includes applying the altered threshold value to a threshold-dependent feature to generate an altered threshold-dependent feature value. The altered threshold-dependent feature value determined at least in part from the event. The method further includes executing a machine learning model, on the event and the altered threshold-dependent feature value, to generate a predicted event type for the event.

In general, in one aspect, one or more embodiments relate to a method that includes obtaining test events, and, for each test event, individually creating at least one test case. Individually creating at least one test case includes altering a threshold pseudo-randomly to generate an altered threshold value, applying the altered threshold value to a threshold-dependent feature to generate an altered threshold-dependent feature value, the altered threshold-dependent feature value determined at least in part from the plurality of test events, and adding the threshold-dependent feature to a test case in the at least one test case. The method further includes iteratively adjusting at least one machine learning model while executing the at least one machine learning model on the at least one test case the test events to generate at least one trained machine learning model.

In general, in one aspect, one or more embodiments relate to a system that includes a server including a processor, and a data repository in communication with the server. The data repository storing an event having an event type, and information regarding the event. The system further includes a machine learning model trained to classify the event. The machine learning model is configured to receive as input the event and the plurality of altered threshold-dependent feature values. The system further includes a server application configured, when executed by the processor, to generate the altered threshold-dependent feature values by altering, using the information regarding the event, thresholds, input, to the machine learning model, the event and the altered threshold-dependent feature values, and generate, as output from the machine learning model, the predicted event type.

Other aspects of the one or more embodiments will be apparent from the following description and the appended claims.

### BRIEF DESCRIPTION OF DRAWINGS

FIG. 1 shows a computing system, in accordance with the one or more embodiments.

FIG. 2 shows a method of using an improved machine learning model, in accordance with the one or more embodiments.

FIG. 3A and FIG. 3B show a method of training an improved machine learning model, in accordance with the one or more embodiments.

FIG. 4 shows an example of altering threshold-dependent features as part of improving the security of a machine learning model, in accordance with the one or more embodiments.

FIG. 5A and FIG. 5B show another computing system, in accordance with the one or more embodiments.

### DETAILED DESCRIPTION

Specific embodiments will now be described in detail with reference to the accompanying figures. Like elements in the various figures are denoted by like reference numerals for consistency.

In the following detailed description of embodiments, numerous specific details are set forth in order to provide a more thorough understanding of the one or more embodiments. However, it will be apparent to one of ordinary skill in the art that the one or more embodiments may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

In general, the one or more embodiments are directed to improving the cybersecurity of machine learning models. Machine learning models used for security purposes use, as input, various feature values of features and produce, as output a security classification. Nefarious users wanting to circumvent the security provided by the machine learning models may attack the indirectly through the inputs to the models. When a machine learning model uses, as input, feature values determined from constant thresholds, such nefarious users are able to learn the thresholds. In particular, one or more embodiments improve the cybersecurity of machine learning models by using a pseudo-random, repeatable technique to vary the thresholds that determine feature values of features used by the machine learning model. Further, because a machine learning model is dependent on the inputs to the machine learning model, one or more embodiments improve the machine learning model itself in order to handle the varying thresholds.

A summary of the one or more embodiments is provided by way of broad example, with the details of the one or more embodiments described with respect to the figures. Initially, an event is detected. An event is an electronic action that is being monitored. Examples of events include login attempts, requests to initiate an electronic transfer of information, attempts to access the use of software, attempts to manipulate data on secured data repositories, attempt to electronically transfer money or electronically pay for a product, etc.

When the event is detected, information about the event is provided as input to a machine learning model. The machine learning model is trained to generate a predicted event type of the event. Specifically, the machine learning model is trained to classify the event into one or two or more event types. The classification may include an individual probability for each event type that the event is of the event type. The event type with the greatest probability may be deemed the predicted event type for the event.

For example, the event types may include fraudulent event type or an authentic (i.e., non-fraudulent) event type. In the example, if the probability of a fraudulent event is below a threshold, the event may be deemed authentic, and the user is allowed to proceed. If the probability of a fraudulent event is above the threshold, the event may be deemed possibly fraudulent and a security action is taken.

An issue encountered in cybersecurity is that a cybercriminal may monitor the behavior of an enterprise system that is protected by such machine learning models. If the behavior of the machine learning models becomes predictable, the criminal is able to circumnavigate the portion of the cybersecurity system protected by the machine learning models. Stated more simply, the cybercriminal figures out how to trick the machine learning models into predicting that a fraudulent event is authentic, or finds a way into causing the machine learning models to fail to make a prediction with respect to the fraudulent activity.

The one or more embodiments improve the machine learning models by making the output of the machine learning models much more difficult to predict through changing the inputs to the machine learning model. In particular, a pseudo-random technique is used to alter the thresholds that used to formulate the input to the machine learning models. When many thresholds are altered at once, the cybercriminal will have difficulty predicting the behavior of the cybersecurity system. Additionally, the cybercriminal may be tricked into believing that he or she has discerned the system's behavior patterns, but in actuality a fraudulent event will be detected and thwarted.

By way of an example, consider the scenario in which the machine learning model detects whether a fraudulent login occurs based on the number of unsuccessful login events in a defined lookback period. If the threshold for the lookback period is statically defined as five days, then the cybercriminal may easily be able to detect the five-day threshold based on response of the system. Using the information, the cybercriminal simply waits six days before trying again circumventing the machine learning model. However, if the threshold for the lookback period changes, then the cybercriminal may not be able to detect the threshold and thus cannot easily circumvent the security provided by the machine learning model. The benefit is compounded when more than just the lookback period or if other thresholds are dynamically modified.

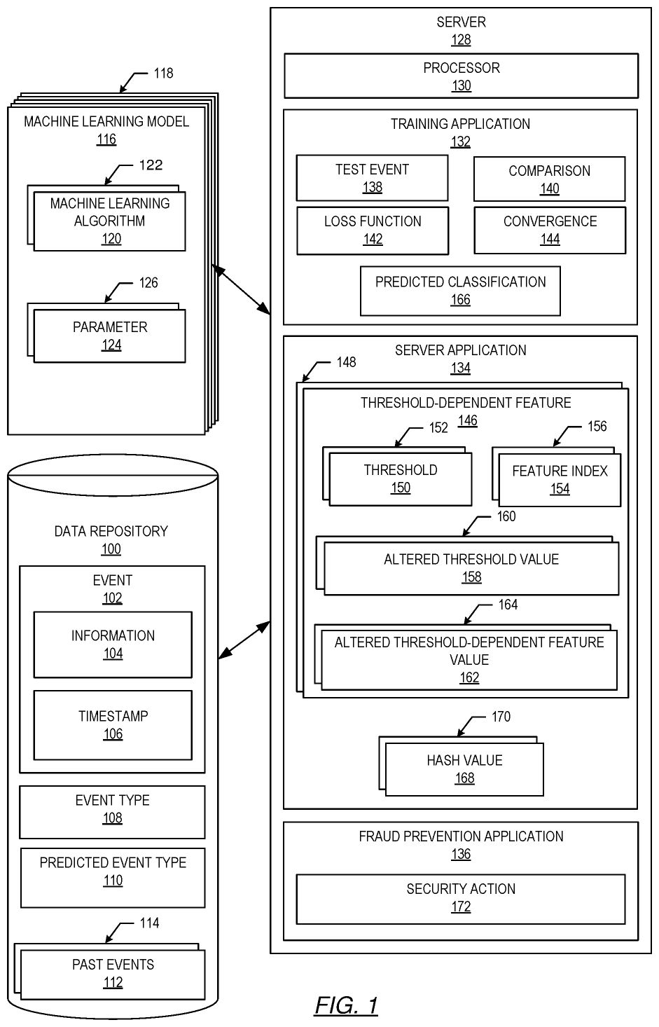

Attention is now turned to the figures. FIG. 1 shows a computing system, in accordance with one or more embodiments. The computing system includes a data repository (100). In one or more embodiments, the data repository (100) is a storage unit and/or device (e.g., a file system, database, collection of tables, or any other storage mechanism) for storing data. Further, the data repository (100) may include multiple different storage units and/or devices. The multiple different storage units and/or devices may or may not be of the same type and may or may not be located at the same physical site.

The data repository (100) stores a variety of information useful to the one or more embodiments. For example, the data repository (100) stores an event (102). As mentioned above, the event (102) is an electronic action that is being monitored. Examples of events include login attempts, requests to initiate an electronic transfer of information, attempts to access the use of software, attempts to manipulate data on secured data repositories, etc.

The data repository (100) stores information (104) about the event (102). The information (104) relates to, or is in regard to, the event (102). The term “regards” means that the information (104) somehow describes some aspect related to the event (102). Thus, for example, the information (104) may be characterized as metadata in that the information (104) describes the event (102). However, the information (104) may also include data that constitutes the event (102) itself.

In a more specific example, the information (104) may include a timestamp (106) of when the event occurred, an identifier pertaining to a user or an account associated with the event, an internet protocol (IP) address from which the event (102) originated or at which the event (102) is processed, etc. The information (104) may take many other different forms. Thus, the timestamp (106) shown in FIG. 1 is an example of information (104) about the event (102).

The event (102) is characterized by an event type (108), also stored in the data repository (100). The event type (108) is a category into which the event (102) has been placed. For example, the event (102) may be classified as fraudulent, authentic, suspicious, secure, insecure, etc. The event type (108) may take many other different forms or categories.

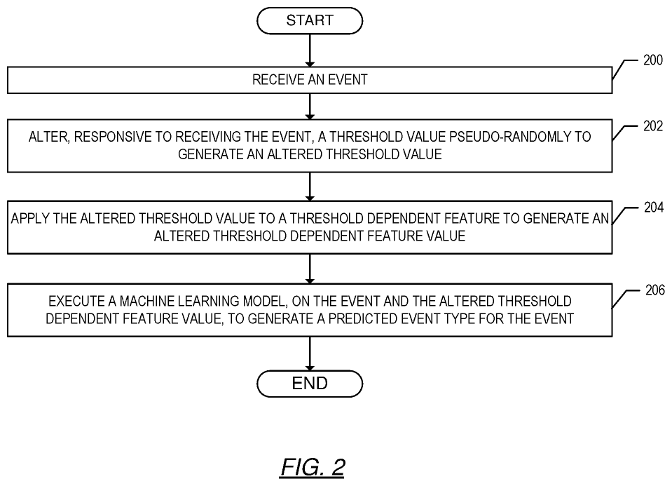

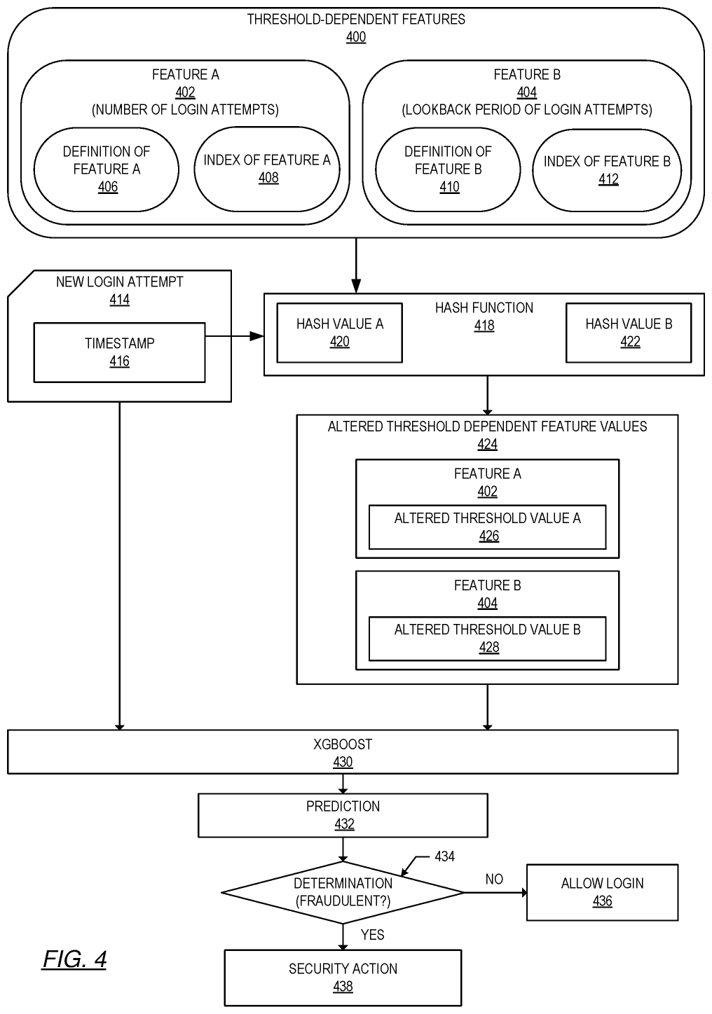

The data repository (100) also stores a predicted event type (110). The predicted event type (110) is a machine-learned prediction of which event type (108) applies to a given incoming event (102). The process of predicting the predicted event type (110) is described further with respect to FIG. 2 and exemplified in FIG. 4.

The data repository (100) also stores past events (112), which, in most cases, is one of multiple past events (114). The past event (112) and the multiple past event (114) are events which have occurred in the past but are stored for informational purposes. Thus, for example, once an incoming event (102) is processed, the incoming event (102) associated with an event type (108) and is added to the multiple past events (114).

The system shown in FIG. 1 also includes one or more machine learning models (116). The machine learning model (116) includes one or more machine learning algorithms (120) together with one or more parameters (124). Any variation of numbers and combinations of types of machine learning models, algorithms, and parameters may be used, unless specified otherwise.

The machine learning algorithm (120) is a computer program that, when executed, produces a prediction based on the input provided and the parameter (124) set for the machine learning algorithm (120). Examples of the machine learning algorithm (120) include supervised learning algorithms and unsupervised learning algorithms. A specific example of a supervised machine learning algorithm used in FIG. 4 is XGBoost, which is a gradient boost algorithm. However, the one or more embodiments contemplate the use of many different types of machine learning algorithms.

The parameter (124) is a number which alters how the machine learning algorithm (120) manipulates the input data. An example of a parameter is a set of weights that is specified for a neural network. The set of weights allow the neural network to produce a related output. However, many different possible parameters exist. Some machine learning algorithms have defined many parameters, though only one parameter may be defined for a given machine learning algorithm.

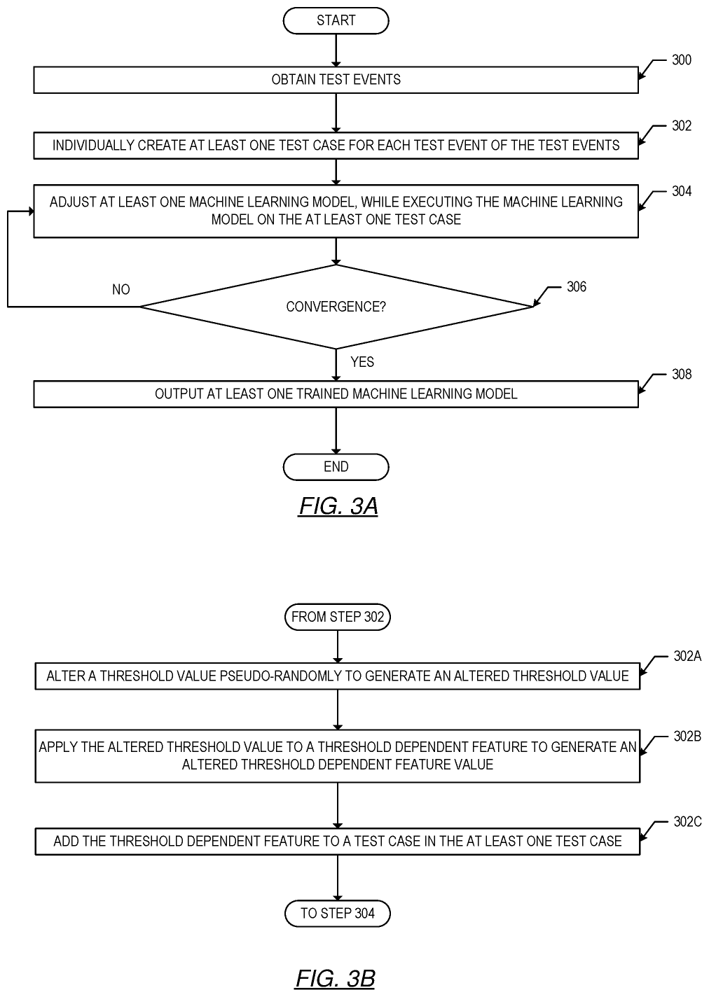

Changing the parameter (124) changes the machine learning model (116), because the output of the machine learning model (116) changes when the parameter (124) changes. Thus, the process of training the machine learning model (116), described with respect to FIG. 3A and FIG. 3B, transforms a machine learning model through the changing parameters. As indicated above, a result of the transformation is that the output of the machine learning model (116) will change. Accordingly, machine learning model (116), when transformed by changing the multiple parameters (126), will be more or less accurate at making predictions. Because the machine learning model is executed by the computing system, one or more increase the accuracy of the computing system in performing the prediction.

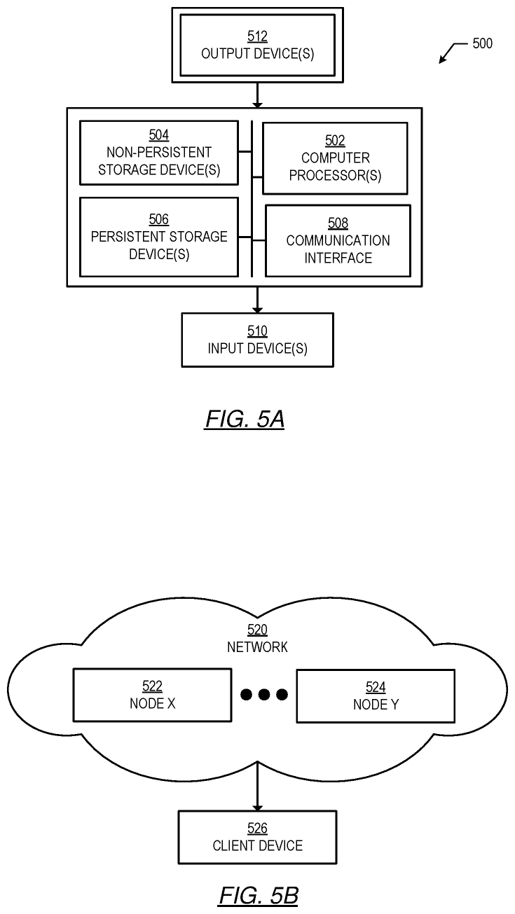

The system shown in FIG. 1 also includes a server (128). The server (128) is one or more computers, possibly in a distributed computing environment, which are programmed to implement the methods described with respect to FIG. 2 through FIG. 3B, as well as the example shown in FIG. 4. An example of the server (128) is shown in FIG. 5A and FIG. 5B.

The server (128) includes at least one processor (130). The processor (130) is computer hardware that is configured to execute software, such as a training application (132), a server application (134), and a fraud prevention application (136). An example of the processor (130) is described with respect to FIG. 5A and FIG. 5B.

The server (128) may also be characterized by the software executing on the server (128). Thus, as indicated above, the server (128) may include the training application (132), the server application (134), and the fraud prevention application (136). Each component is described in turn. Note that the information described with respect to each component may be stored in the data repository (100).

Attention is first turned to the training application (132). The training application (132) is one or more software programs that, when executed by the processor (130), operate to train the machine learning model (116) and/or the multiple machine learning models (118). Operation of the training application (132) is described with respect to FIG. 3A and FIG. 3B.

The training application (132) uses a test event (138) having one or more test cases. The test event (138) may be one of many different test events. The test event (138) is a past event that has a known event type (112). For example, the test event (138) may be a login attempt which is known to be classified as fraudulent. Another, different, test event (138) may be another login attempt which is known to be classified as authentic.

As described further with respect to FIG. 3A and FIG. 3B, the test event (138) is used to create one or more test cases. A test case is the test event with a defined set of feature values (described below). For example, a test case may be the test event after the randomization is applied to the thresholds and the feature values are determined. A single test event may have multiple test cases or a single test case. For example, in some embodiments, a machine learning model is trained using a single test case per test event. In another example, multiple machine learning models may be trained using corresponding test cases for the same test event. The machine learning algorithm (120) outputs a prediction that predicts whether the test event (138) is of a particular event type. The prediction is a predicted classification (166) of the test event (138) to an event type.

The fact that the actual event type is already known is used to train the model, as described with respect to FIG. 3A and FIG. 3B. For example, the training application (132) generates a comparison (140) between the predicted classification (166) and the actual event type for the test event (138). In other words, the comparison (140) is a number or a sequence of numbers that define the differences between the actual type of the test event (138) and the predicted type of the test event (138).

The comparison (140) is used to generate a loss function (142), as described with respect to FIG. 3A and FIG. 3B. The loss function (142) is a value, a series of values, or an algorithm having an output. The loss function (142) represents a calculated guess as to which changes to the parameter (124) or the multiple parameters (126) are more likely to decrease the differences between the known test even type and the next predicted test event type. The loss function (142) thus is used to change the parameter (124) and/or the multiple parameters (126). Stated differently, the loss function (142) will change the parameter (124) so that the predicted similarity (166) for the test event (138) will change when the machine learning algorithm (120) is executed again.

As described with respect to FIG. 3A and FIG. 3B, the process is iterated. The process is iterated until convergence (144). Convergence (144) is a stop condition which causes the iterative process of training the machine learning model (116) to stop because the machine learning model (116) is considered by a computer scientist to be sufficiently trained. Convergence (144) may occur based on a number of criteria. For example, the convergence (144) may occur when the comparison (140) falls below a threshold value. The convergence (144) may occur when a difference between the current comparison (140) and the prior comparison (140) on the last iteration falls below another threshold value. Other stop criteria may define the convergence (144), though once the convergence (144) is achieved the machine learning model (116) is deemed trained. Other stop conditions may be used without departing from the scope of the claims.

Attention is now turned to the server application (134). The server application (134) is one or more software programs that, when executed by the processor (130), operate to perform the one or more embodiments described with respect to FIG. 2 and exemplified by FIG. 4.

The server application (134) uses certain kinds of data in the performance of the methods of FIG. 2 through FIG. 3B. For example, the server application (134) uses a threshold-dependent feature (146), which may be one of multiple threshold-dependent features (148). The threshold-dependent feature (146) is a feature that is dependent on a threshold value.

In general, a “feature” is an individual measurable property (e.g., characteristic) that is related to and directly or indirectly determinable at least in part from an event. For example, a feature may be a number of past events having a same attribute value as the event. A feature has a feature value. The feature value is the value of the feature for a particular event. For a threshold-dependent feature, the feature value is dictated by the threshold. For some features in at least one embodiment, the feature value may be value is a numerical representation that quantifies the feature. For example, if the feature represents the number of past login attempts, then the number “5” would represent five past login attempts.

A feature value may be stored in a cell in a vector. The vector is a data structure that is used to provide input data to the machine learning model (116). Thus, it can be said that the machine learning model (116) executes on the input data, or that the machine learning model (116) executes on the vector. It can also be said that the vector is composed of features.

For example, a feature may be the current number of login attempts received. The feature may be the internet protocol address from which a given login attempt is received. A feature may be a lookback feature. A lookback feature is a feature whose values is dependent on a past period of time. Many features are possible. In a real setting, a vector may include hundreds, or even thousands of features.

The following is an example list of threshold dependent features. (1) Is total amount of purchases in the previous time period greater first threshold, whereby the time period is defined by a second threshold? (2) Is total amount of logins to the account in previous time period greater than a first threshold, whereby the time period is defined by a second threshold? (3) Is the total amount of account creations from an IP address greater than a first threshold, whereby the time period is defined by a second threshold? (4) Is the total amount of credit already given to the user greater than a threshold? (5) Is the total amount of loans already returned by the user greater than a threshold? Other example of threshold dependent features are aggregation features. Aggregation features returns a number, such as a count of a particular attribute value within a time period, whereby the time period is defined by a threshold. The above are only a few examples of threshold dependent features, other threshold dependent features may be used without departing from the scope of the claims.

Returning to the threshold-dependent feature (146), again is defined as a feature which depends on a threshold value. A lookback feature is an example of the threshold-dependent feature (146), as the lookback feature defines a length of a lookback period (the amount of time a data set is to be analyzed). Another example of the threshold-dependent feature (146) is a defined number of logins attempts that are allowed until a security action is taken. Another example of the threshold-dependent feature (146) is a rate at which login attempts are made over a defined time period. Many different forms of the threshold-dependent feature (146) are possible.

As indicated above, the threshold-dependent feature (146) is defined by a threshold (150) having a threshold value. Accordingly, multiple thresholds (152) may be defined for multiple threshold-dependent features (148), on a one-for-one basis. The threshold value of a threshold (150) is a numerical representation of a limit set for the threshold-dependent feature (146), as described above.

A feature index (154) is defined for the threshold-dependent feature (146). Likewise, multiple feature indices (156) are defined for the multiple threshold-dependent features (148). The feature index (154) is a unique identifier of a feature amongst the various features used by the machine learning model. In one or more embodiments, the feature index (154). In one or more embodiments, the feature index may be a unique identifier of the location of feature value of the feature in the vector, described above.

The one or more embodiments alter the threshold-dependent feature (146). In particular, the one or more embodiments provide for a method for establishing an altered threshold value (158) for the threshold-dependent feature (146). Likewise, it is possible for multiple altered threshold values (160) to be defined for multiple threshold-dependent features (148). The term “altered” means that the threshold (150) is a dynamic threshold that is changed pseudo-randomly. The method of altering is described with respect to FIG. 2.

The altered threshold value (158) is applied to the threshold-dependent feature (146) to establish an altered threshold-dependent feature value (162). Likewise, multiple altered threshold-dependent feature values (164) are applied to the multiple threshold-dependent features (148) to establish multiple altered threshold-dependent feature values (164). The process of establishing the altered threshold-dependent feature value (162) is described with respect to FIG. 2.

The server application (134) may use a hash value (168) to establish the altered threshold value (158). Similarly, the server application (134) may use multiple hash values (170) to establish multiple altered threshold values (160). A hash value is the numerical result of a hash function applied to an input. In one or more embodiments, the hash function is deterministic. Namely, the inputs to the hash function and the hash function itself are defined such that the same inputs produce the same hash value. For example, the hash function may use as input a timestamp (106) of the event and the feature index. An example hash function may be an exclusive or (XOR) based hash function. In one or more embodiments, the hash value (168) maps to an altered threshold value in a range of allowed threshold values. The range of allowed threshold values may be defined, for example, by a user. The process of establishing the hash value (168) is described with respect to FIG. 2.

The use of the hash value (168) is an example of a method of performing a pseudo-random alteration of the threshold value (150). The term “pseudo-random” is defined as a method of generating the altered threshold value (158) such that the altered threshold value (158) is sufficiently unpredictable. The term “sufficiently unpredictable” means that an external observer will have difficulty identifying a pattern in the results produced by multiple applications of the method.

For example, without knowing the basis or bases for the hash algorithm, it is difficult to predict the altered threshold value (158) that is produced by the hash algorithm over multiple iterations. The difficulty increases exponentially when different bases for the hash algorithm are applied to different ones of multiple threshold-dependent features (148). For example, the multiple altered threshold-dependent feature values (164) could be based hashes of the multiple feature indices (156) for each of the features. However, unless an external observer knows the order in which the features are arranged in the input vector, the results of applying the hash algorithm appear unpredictable.

The unpredictability increases to the external user because what an external observer observes is not the altered threshold value (158) itself, but rather the behavior of the fraud prevention application (136). In turn, the fraud prevention application (136) is based on the output of the machine learning algorithm (120), which only uses the multiple altered threshold values (160) as input. Thus, to an external user, the fraud prevention application (136) behavior appears random, even though an administrator in control of the system of FIG. 1 knows precisely how to reproduce the altered threshold value (158). Because the processes described above appear sufficiently unpredictable, but are not truly random, the term “pseudo-random” is used.

The system shown in FIG. 1 also includes a fraud prevention application (136). The fraud prevention application (136) is software which, when executed, performs a security action (172) in response to the predicted event type (110) matching a pre-determined event type. For example, the fraud prevention application (136) may be software which prevents, for a predetermined time, further login attempts to an account after a login attempt is predicted to be fraudulent. The security action (172) may also include denying access to a financial services application, reporting the event, blocking an internet protocol address, banning a user account, requiring additional security protocols prior to granting access to a protected application, etc. The security action (172) may also include grant actions, such as granting access to an account when a pre-determined security level is achieved, allowing a transaction, etc. An example of the operation of the fraud prevention application (136) is described with respect to FIG. 4.

While FIG. 1 shows a configuration of components, other configurations may be used without departing from the scope of the one or more embodiments. For example, various components may be combined to create a single component. As another example, the functionality performed by a single component may be performed by two or more components.

FIG. 2 and FIG. 3 are flowcharts, in accordance with one or more embodiments. The flowcharts of FIG. 2 and FIG. 3 may be implemented using the system shown in FIG. 1. An example of an implementation of the method of FIG. 2 is shown in FIG. 4.

Step 200 includes receiving an event. The event is received via a communication network, such as the Internet. In a specific example, a login event is received at the server from a web browser on a remote user device. In another example, a login event is received when a user attempts to transfer more than a certain amount of money from or to an account.

Step 202 includes altering, responsive to receiving the event, a threshold pseudo-randomly to generate an altered threshold value. Altering the threshold pseudo-randomly may be achieved by applying a hash function to a feature index with a timestamp. Altering the threshold pseudo-randomly may additionally or alternatively use other values as inputs to the hash function, such as an identifier of a user, an account number associated with the event, combinations thereof. The result of the hash function is a hash value. In one or more embodiments, the hash value is used directly as the altered threshold value. In one or more embodiments, the hash value is used as input to a mapping function that maps the hash value to the altered threshold values. By way of an example, the mapping function may map a different ranges of hash values to a corresponding altered threshold value in a set of allowed altered threshold values. Thus, from the hash value, the range of the hash value is determined, and the corresponding altered threshold value is determined. By way of an example, if the result of the hash function is 1.345 and the range from 1 to 2 maps to altered threshold value 5 while different ranges map to different corresponding threshold values, then the result of the mapping function for 1.345 is an altered threshold value of 5. The set of allowed altered threshold values may be defined on a discrete (e.g., any integer within a range) or on a continuous scale (e.g., any number within a range). Further, the set of allowed altered threshold values may be enumerated (e.g., “4, 5, and 8 are allowed values”) or implicitly defined (e.g., “integers between 1 and 8 are allowed values”).

Altering the threshold pseudo-randomly may also be achieved by altering the threshold according to an algorithm that takes, as input, a process that is random. The random number is stored so that the original threshold value can be reconstructed, when desired. Other techniques for altering the threshold pseud-randomly exist.

Step 204 includes applying the altered threshold value to a threshold-dependent feature to generate an altered threshold-dependent feature value. The altered threshold-dependent feature value is determined at least in part from the event. Directly or indirectly from the event, one or more feature values are determined. Each feature specifies a collection of one or more attributes to combine into the feature value. The attribute value may be the feature value. As another example, the feature value may be determined from a function performed on one or more attribute values. The attribute values may be attributes values in the event, in previous events, attributes of the target of the event or other attributes. For example, the attribute may be the number of log-in attempts by the same internet protocol (IP) address as the event. In such a scenario, the attribute value is the IP address of the event, the function is the number of log-in attempts from the IP address in previous attempts. For at least one threshold-dependent feature, the altered threshold value is used when applying the function. For example, for lookback features, the altered threshold value is on the number of events, period of time of the lookback feature, or other value.

Feature values for the one or more features may be added to a vector. The Steps 202 and 204 may be performed for multiple features to use multiple altered threshold values for the multiple features. The result of Step 204 across the feature may be the vector that is used as input to the machine learning model.

Step 206 includes executing a machine learning model, on the event and the altered threshold-dependent feature value, to generate a predicted event type for the event. As described above with respect to FIG. 1, a machine learning model is executed on the event and the altered threshold-dependent feature value when the vector containing the feature value is used as input to the machine learning model. Executing the machine learning model on the event is to use the event directly or indirectly as input. For example, executing the machine learning model on the event may be to use the vector as input to the machine learning model. The machine learning algorithm then operates on the vector and produces an output.

The result of executing the machine learning model is a number or a string of numbers that represent one or more predictions that the input matches one or more pre-defined event types. Thus, for example, an output of the machine learning model might be that the input has a 1% chance of matching a fraudulent event type 1, a 5% chance of matching a fraudulent event type 2, a 10% chance of matching a fraudulent event type 3, and a and a 84% chance of matching an authentic event type. The highest number is selected, by the server application, resulting in an overall prediction that the input data matches an authentic event type.

Optionally, the output of the machine learning model may be subject to further machine learning. For example, a confidence machine learning model, such as a logistic regression algorithm, could be used to measure a probability that the output of the prediction machine learning model is correct. The confidence could be used as part of the basis that the server application uses to determine which of a number of different event types should be applied to the current event input into the prediction machine learning model.

In any case, once the event type is predicted for the incoming event, the method of FIG. 2 may terminate. However, other actions may be taken after step 206. For example, a security action could be taken, such as described with respect to the example FIG. 4.

The method of FIG. 2 may be varied. For example, at step 202, altering the threshold pseud-randomly may be performed multiple threshold-dependent features to generate multiple altered threshold-dependent feature values. In this case, the multiple of altered threshold-dependent feature values are used when executing the machine learning model. By altering the thresholds of multiple threshold-dependent features, the ultimate behavior of the prediction machine learning model becomes more difficult to predict (relative to only varying the threshold of one threshold-dependent feature).

The unpredictability of the model can be further increased by ensuring that the altered threshold-dependent values are all different, and determine differently, for each threshold-dependent feature. Thus, in this case, at least two of the plurality of altered threshold values are different.

In another variation to the method of FIG. 1, the threshold-dependent features may be a lookback feature. In this case, the threshold values are a threshold or thresholds defining a length of a lookback period. For example, by varying a lookback period, the algorithm could refer to the login attempts stored for accessing a given account over the course of four days, but the transactions performed for that account over the course of eight days.

Alternatively, the threshold-dependent features may be a number of occurrences of multiple past events satisfying a criterion for matching the event. For example, eight login attempts could be used as a reference for one set of inputs, but twelve login attempts could be used as a reference for another.

The altered threshold value at step 202 may also be limited to be within a range. For example, a lookback value of twelve years may be deemed excessive. Thus, the server application may limit the lookback period to be a time between five days and twenty days, in one example.

The unpredictability of the behavior of the security system can be further increased by using multiple different prediction machine learning models, which use altered threshold-dependent features. However, in this example, a random or a pseudo-random process may be used to determine which of multiple machine learning models are used to perform a prediction. As each machine learning model is different, either because the parameters are different or because the machine learning algorithms are different, or both, the output becomes less predictable. In the multiple machine learning model embodiment, altering the threshold value is performed by in the pseudorandom selection of the machine learning model from a set of machine learning models.

Thus, the one or more embodiments also contemplate selecting the machine learning model from among multiple machine learning models. The multiple machine learning models each correspond to a distinct corresponding set of one or more altered threshold values. The distinct correspond set of one or more altered threshold values are each altered pseudo-randomly when training the respective machine learning models. Namely, in one or more embodiments, the one or more altered threshold values are statically defined for a particular machine learning model, but the selection of the machine learning model is pseudorandom resulting in a pseudorandom alteration of the one or more thresholds.

Any given pseudo-random number may be generated from information regarding the event. Thus, for example, information regarding the event may be used to generate a pseudo-random number that is used to select the machine learning model applied to a given event. Concurrently, the pseudo-random number may be used to identifying the distinct corresponding set of one or more altered threshold values matching the pseudo-random number.

As indicated above, generating the pseudo-random number may include generating a hash of a timestamp of the event with an index of a selected feature of the threshold-dependent features. However, other methods may be used, such as to generate a hash of a username of an account associated with the event with an index of the selected feature.

The one or more embodiments also contemplate more efficient techniques for accessing differing values of the threshold-dependent features. When many different events are processed concurrently, the speed of accessing different values of different thresholds may be an issue.

Thus, the one or more embodiments also contemplate storing counts for the threshold-dependent feature in an array. Storing the counts includes storing different values for the threshold-dependent features in the array. For example, if the threshold-dependent feature is a lookback feature such as the number of login attempts per day over a five day period, then the value for each day may be stored in the rows of the array.

Then, responsive to receiving the event and altering the threshold value, a subset of the plurality of counts is selected according to the altered threshold value to obtain a selected subset. For example, if the altered threshold value is moved from one day to five days, then the array is accessed at the five-day entry. However, if the altered threshold value is moved to two days, then the array is accessed at the two-day entry.

In an embodiment, the subset may be aggregated and used as the altered threshold-dependent feature value. Thus, the method may include aggregating, responsive to receiving the event and altering the threshold value, the selected subset to generate the altered threshold-dependent feature value. Still other variations are possible.

Attention is now turned to FIG. 3A and FIG. 3B. FIG. 3A is a method of training a machine learning model or multiple machine learning models to perform the method of FIG. 2. FIG. 3B is a process that may be used to perform step 302 of FIG. 3A.

As indicated above with respect to FIG. 1, the process of training a machine learning model involves executing the machine learning model on training data for which the results are known. A predicted result is generated and compared to the known result. If the predicted result does not match the known result, then the machine learning model parameter or parameters are adjusted, and a new predicted result is generated on the same training data. The process iterates until convergence.

Thus, step 300 includes obtaining test events. The test events are obtained from past events for which event types are known. For example, by analyzing patterns in the data, or from analyzing past security issues, it may be known that certain events correspond to fraudulent events and other events correspond to authentic events. In some cases, different kinds of fraudulent event types may be known.

Step 302 then includes individually creating at least one test case for each test event of the plurality of test events. The test cases may be created according to the method of FIG. 3B, described further below. However, generally, the test cases are generated by altering the values of the threshold-dependent features in a pseudo-random manner, as described above with respect to FIG. 2.

Step 304 includes adjusting at least one machine learning model while executing the at least one machine learning model on the at least one test case. Each test case may correspond to an individual vector that is used as input to the machine learning model. Thus, the machine learning model is executed as described above with reference to Step 206 of FIG. 2. Adjusting the machine learning model may be performed by adjusting one or more parameters of the machine learning model. Adjusting the machine learning model may also be performed by changing the machine learning algorithm. In many embodiments, only the parameter or parameters are adjusted.

The parameters are adjusted by way of a loss function. As described with respect to FIG. 1, the loss function is a calculated guess as to which parameter(s) are to be changed and by how much in order to increase a likelihood that the next iteration of training will be closer to convergence.

Step 306 includes determining whether convergence has occurred. If convergence has occurred (a “yes” determination at step 306), then the method proceeds to step 308 where the at least one trained machine learning model is output. In most cases, multiple machine learning models are output, one for each test case. Otherwise, (a “no” determination at step 306), then the method returns to step 304 and iterates.

If the machine learning model is a single machine learning model being trained, whereby the single machine learning model uses features having altered threshold values, then each test event may result in a single test case. By having a single test case per test event, the machine learning model is trained to handle the variability that exists when the machine learning model is used in production.

The method of FIG. 3A may be varied. For example, the at least one machine learning model may be a single machine learning model and the at least one test case is a single test case. However, the at least one machine learning model may be multiple machine learning models. In such a scenario, each of the machine learning models is a distinct corresponding set of one or more altered threshold values. In other words, each of the test cases may be a set of feature values determined specifically for the corresponding machine learning model using the corresponding set of differently altered threshold-dependent features. Stated differently, creating the at least one test case may include individually creating a corresponding test case for each of the machine learning models according to the distinct corresponding set of one or more altered threshold values.

The method of FIG. 3B may be extended to production. Production includes inputting live data into the at least one trained machine learning model. Inputting live data means that data having unknown event types is provided as input to the at least one trained machine learning model, and it is desired to predict the event types for the live data.

Thus, in the extended method, a new event is received. A selected one of a first trained machine learning model and a second trained machine learning model of the at least one trained machine learning model is pseudo-randomly determined. Then, a prediction is performed, by the selected one of the first trained machine learning model and the second trained machine learning model, whether the new event matches a pre-determined event type.

Attention is now turned to FIG. 3B. Again, FIG. 3B is one exemplary technique for implementing step 302 of FIG. 3A.

Step 302A includes altering a threshold value pseudo-randomly to generate an altered threshold value. The process of altering a value pseudo-randomly is described above with respect to FIG. 2 and FIG. 1.

Step 302B includes applying the altered threshold value to a threshold-dependent feature to generate an altered threshold-dependent feature value. The altered threshold-dependent feature value is determined at least in part from the event. The process of applying the altered threshold value is described above with respect to FIG. 2 and FIG. 1.

Step 302C includes adding the threshold-dependent feature to a test case in the at least one test case. The threshold-dependent feature is added to a test case by including the altered threshold-dependent feature in the input that is to be used for a selected machine learning model.

While the various steps in the flowcharts of FIG. 2, FIG. 3A, and FIG. 3B are presented and described sequentially, one of ordinary skill will appreciate that some or all of the steps may be executed in different orders, may be combined or omitted, and some or all of the steps may be executed in parallel. Furthermore, the steps may be performed actively or passively. For example, some steps may be performed using polling or be interrupt driven in accordance with one or more embodiments. By way of an example, determination steps may not require a processor to process an instruction unless an interrupt is received to signify that condition exists in accordance with one or more embodiments. As another example, determination steps may be performed by performing a test, such as checking a data value to test whether the value is consistent with the tested condition in accordance with one or more embodiments. Thus, the one or more embodiments are not necessarily limited by the examples provided herein.

FIG. 4 presents a specific example of the techniques described above with respect to FIG. 1 through FIG. 3B. The following example is for explanatory purposes only and not intended to limit the scope of the one or more embodiments.

In the example of FIG. 4, a machine learning model (described further below) is used to determine whether a login attempt is fraudulent or authentic. The owner of the system desires to allow authentic logins, but thwart fraudulent logins. Because a machine learning model relies on a vector of features, the example of FIG. 4 begins with considering the features that will be used as input to the machine learning model.

In particular, reference is made to the threshold dependent features (400). The threshold-dependent features (400) include such features, feature A (402) and feature B (404). Feature A (402) is the number of login attempts for an account. Feature B (404) is the lookback period for the number of login attempts. In other words, feature B (404) represents how many days in the past to look at the number of login attempts. Feature A (402) represents the number of login attempts on any given day, or possibly the accumulated number of login attempts made over the lookback period specified by feature B (404).

Each of feature A (402) and feature B (404) has definition of the feature an index. Thus, feature A (402) has a definition of feature A (406) and an index of feature A (408). Likewise, the feature B (404) has a definition of feature B (410) and an index of feature B (412).

In the example of FIG. 4, a new login attempt (414) is received. The new login attempt (414) is associated with a timestamp (416), representing the time the new login attempt (414) was attempted. A hash function (418) is then applied, using information regarding the new login attempt (414) and information regarding one or both of the threshold-dependent features (400).

In this example, the hash function (418) is performed on the timestamp (416) and the index of feature A (408) to generate a hash value A (420). Similarly, the hash function (418) is performed on the timestamp (416) and the index of feature B (412) to generate a hash value B (422).

The hash values, in turn, are used to alter the thresholds for feature A (402) and for feature B (404), respectively. For example, the hash value A (420) is mapped to an altered threshold value A (426). Further, hash value B (422) is mapped to the altered threshold value B (428). Because different indexes are used, different hash values result for different features of the same event. Note that both processes are examples of step 202 of FIG. 2 (altering a threshold value pseudo-randomly).

In the example of FIG. 4, the altered thresholds are applied to the threshold-dependent features (400) to generate the altered threshold dependent feature values (424). In particular, the altered thresholds are substituted for the original threshold numbers. Thus, the altered threshold dependent feature values (424) now use feature A (402) with the altered threshold A (426) and the feature B (404) with the altered threshold B (428). Thus, the generation of the altered threshold dependent feature values (424) is an example of step 204 of FIG. 2 (applying the altered threshold value to a threshold dependent feature to generate an altered threshold dependent feature).

The altered threshold dependent features (424) are provided as input to an XGBoost (430) machine learning model. Other features may also be provided as input to the XGBoost (430) machine learning model. In addition, information regarding the new login attempt (414) is converted into additional features and provided as input to the XGBoost (430) machine learning model.

The XGBoost (430) machine learning model is then executed. The result of the execution is a prediction (432). The prediction (432) is one or more predictions of probabilities that the new login attempt (414) corresponds to either an authentic login attempt (event type A) or a fraudulent event type (event type B). For example, the prediction (432) may be only a single probability that the new login attempt (414) is fraudulent. However, the prediction (432) may take the form of two numbers, one representing a first probability that the new login attempt (414) is fraudulent, and the other representing a second probability that the new login attempt (414) is authentic. Note that the prediction (432) could include other predicted probabilities, such as probabilities that the new login attempt (414) represents one of different methods of fraudulently logging into the protected account.

The server application then performs a determination (434). In particular, the determination (434) is whether the new login attempt (414) is fraudulent. For example, if the prediction (432) is above a threshold value of 80% that the new login attempt (414) is fraudulent, then a security action (438) is taken (a “yes” at determination (434)). However, if the prediction (432) is below the threshold value, then the allow login (436) action is performed, and the user is granted access to the account.

The security action (438) may take a variety of different forms. For example, the security action (438) may be to provide the user with an additional challenge to ensure that the new login attempt (414) is authentic. For example, the user may be presented with a two-factor authentication challenge to ensure it is the authorized user who initiated the new login attempt (414). If the two-factor authentication check passes, the allow login (436) action is taken. However, if the two-factor authentication check fails, then the login attempt is denied.

Still other examples of the security action (438) are possible. The new login attempt (414) may be denied outright. The new login attempt (414) may be reported to an authority. The new login attempt (414) may be sent for further analysis to determine an internet protocol (IP) address of the remote computer from which the new login attempt (414) was received. The IP address can then be tracked or blocked. Still other examples of the security action (438) are possible.

FIG. 5A and FIG. 5B are examples of a computing system and a network, in accordance with the one or more embodiments. The one or more embodiments may be implemented on a computing system specifically designed to achieve an improved technological result. When implemented in a computing system, the features and elements of the disclosure provide a significant technological advancement over computing systems that do not implement the features and elements of the disclosure. Any combination of mobile, desktop, server, router, switch, embedded device, or other types of hardware may be improved by including the features and elements described in the disclosure. For example, as shown in FIG. 5A, the computing system (500) may include one or more computer processor(s) (502), non-persistent storage device(s) (504) (e.g., volatile memory, such as random access memory (RAM), cache memory), persistent storage device(s) (506) (e.g., a hard disk, an optical drive such as a compact disk (CD) drive or digital versatile disk (DVD) drive, a flash memory, etc.), a communication interface (508) (e.g., Bluetooth interface, infrared interface, network interface, optical interface, etc.), and numerous other elements and functionalities that implement the features and elements of the disclosure.

The computer processor(s) (502) may be an integrated circuit for processing instructions. For example, the computer processor(s) (502) may be one or more cores or micro-cores of a processor. The computing system (500) may also include one or more input device(s) (510), such as a touchscreen, a keyboard, a mouse, a microphone, a touchpad, an electronic pen, or any other type of input device.

The communication interface (508) may include an integrated circuit for connecting the computing system (500) to a network (not shown) (e.g., a local area network (LAN), a wide area network (WAN) such as the Internet, a mobile network, or any other type of network) and/or to another device, such as another computing device.

Further, the computing system (500) may include one or more output device(s) (512), such as a screen (e.g., a liquid crystal display (LCD), a plasma display, a touchscreen, a cathode ray tube (CRT) monitor, a projector, or other display device), a printer, an external storage, or any other output device. One or more of the output device(s) (512) may be the same or different from the input device(s) (510). The input and output device(s) (510 and 512) may be locally or remotely connected to the computer processor(s) (502), the non-persistent storage device(s) (504), and the persistent storage device(s) (506). Many different types of computing systems exist, and the aforementioned input and output device(s) (510 and 512) may take other forms.

Software instructions in the form of computer readable program code to perform the one or more embodiments may be stored, in whole or in part, temporarily or permanently, on a non-transitory computer readable medium such as a CD, a DVD, a storage device, a diskette, a tape, flash memory, physical memory, or any other computer readable storage medium. Specifically, the software instructions may correspond to computer readable program code that, when executed by a processor(s), is configured to perform the one or more embodiments.

The computing system (500) in FIG. 5A may be connected to or be a part of a network. For example, as shown in FIG. 5B, the network (520) may include multiple nodes (e.g., node X (522), node Y (524)). Each node may correspond to a computing system, such as the computing system (500) shown in FIG. 5A, or a group of nodes combined may correspond to the computing system (500) shown in FIG. 5A. By way of an example, the one or more embodiments may be implemented on a node of a distributed system that is connected to other nodes. By way of another example, the one or more embodiments may be implemented on a distributed computing system having multiple nodes, where each portion of the one or more embodiments may be located on a different node within the distributed computing system. Further, one or more elements of the aforementioned computing system (500) may be located at a remote location and connected to the other elements over a network.

Although not shown in FIG. 5B, the node may correspond to a blade in a server chassis that is connected to other nodes via a backplane. By way of another example, the node may correspond to a server in a data center. By way of another example, the node may correspond to a computer processor or micro-core of a computer processor with shared memory and/or resources.

The nodes (e.g., node X (522), node Y (524)) in the network (520) may be configured to provide services for a client device (526). For example, the nodes may be part of a cloud computing system. The nodes may include functionality to receive requests from the client device (526) and transmit responses to the client device (526). The client device (526) may be a computing system, such as the computing system (500) shown in FIG. 5A. Further, the client device (526) may include and/or perform all or a portion of the one or more embodiments.

The computing system (500) or group of computing systems described in FIGS. 5A and 5B may include functionality to perform a variety of operations disclosed herein. For example, the computing system(s) may perform communication between processes on the same or different system. A variety of mechanisms, employing some form of active or passive communication, may facilitate the exchange of data between processes on the same device. Examples representative of these inter-process communications include, but are not limited to, the implementation of a file, a signal, a socket, a message queue, a pipeline, a semaphore, shared memory, message passing, and a memory-mapped file. Further details pertaining to a couple of these non-limiting examples are provided below.

Based on the client-server networking model, sockets may serve as interfaces or communication channel end-points enabling bidirectional data transfer between processes on the same device. Foremost, following the client-server networking model, a server process (e.g., a process that provides data) may create a first socket object. Next, the server process binds the first socket object, thereby associating the first socket object with a unique name and/or address. After creating and binding the first socket object, the server process then waits and listens for incoming connection requests from one or more client processes (e.g., processes that seek data). At this point, when a client process wishes to obtain data from a server process, the client process starts by creating a second socket object. The client process then proceeds to generate a connection request that includes at least the second socket object and the unique name and/or address associated with the first socket object. The client process then transmits the connection request to the server process. Depending on availability, the server process may accept the connection request, establishing a communication channel with the client process, or the server process, busy in handling other operations, may queue the connection request in a buffer until server process is ready. An established connection informs the client process that communications may commence. In response, the client process may generate a data request specifying the data that the client process wishes to obtain. The data request is subsequently transmitted to the server process. Upon receiving the data request, the server process analyzes the request and gathers the requested data. Finally, the server process then generates a reply including at least the requested data and transmits the reply to the client process. The data may be transferred, more commonly, as datagrams or a stream of characters (e.g., bytes).

Shared memory refers to the allocation of virtual memory space in order to substantiate a mechanism for which data may be communicated and/or accessed by multiple processes. In implementing shared memory, an initializing process first creates a shareable segment in persistent or non-persistent storage. Post creation, the initializing process then mounts the shareable segment, subsequently mapping the shareable segment into the address space associated with the initializing process. Following the mounting, the initializing process proceeds to identify and grant access permission to one or more authorized processes that may also write and read data to and from the shareable segment. Changes made to the data in the shareable segment by one process may immediately affect other processes, which are also linked to the shareable segment. Further, when one of the authorized processes accesses the shareable segment, the shareable segment maps to the address space of that authorized process. Often, only one authorized process may mount the shareable segment, other than the initializing process, at any given time.

Other techniques may be used to share data, such as the various data described in the present application, between processes without departing from the scope of the one or more embodiments. The processes may be part of the same or different application and may execute on the same or different computing system.

Rather than or in addition to sharing data between processes, the computing system performing the one or more embodiments may include functionality to receive data from a user. For example, in one or more embodiments, a user may submit data via a graphical user interface (GUI) on the user device. Data may be submitted via the graphical user interface by a user selecting one or more graphical user interface widgets or inserting text and other data into graphical user interface widgets using a touchpad, a keyboard, a mouse, or any other input device. In response to selecting a particular item, information regarding the particular item may be obtained from persistent or non-persistent storage by the computer processor. Upon selection of the item by the user, the contents of the obtained data regarding the particular item may be displayed on the user device in response to the user's selection.

By way of another example, a request to obtain data regarding the particular item may be sent to a server operatively connected to the user device through a network. For example, the user may select a uniform resource locator (URL) link within a web client of the user device, thereby initiating a Hypertext Transfer Protocol (HTTP) or other protocol request being sent to the network host associated with the URL. In response to the request, the server may extract the data regarding the particular selected item and send the data to the device that initiated the request. Once the user device has received the data regarding the particular item, the contents of the received data regarding the particular item may be displayed on the user device in response to the user's selection. Further to the above example, the data received from the server after selecting the URL link may provide a web page in Hyper Text Markup Language (HTML) that may be rendered by the web client and displayed on the user device.

Once data is obtained, such as by using techniques described above or from storage, the computing system, in performing the one or more embodiments, may extract one or more data items from the obtained data. For example, the extraction may be performed as follows by the computing system (500) in FIG. 5A. First, the organizing pattern (e.g., grammar, schema, layout) of the data is determined, which may be based on one or more of the following: position (e.g., bit or column position, Nth token in a data stream, etc.), attribute (where the attribute is associated with one or more values), or a hierarchical/tree structure (consisting of layers of nodes at different levels of detail-such as in nested packet headers or nested document sections). Then, the raw, unprocessed stream of data symbols is parsed, in the context of the organizing pattern, into a stream (or layered structure) of tokens (where each token may have an associated token “type”).

Next, extraction criteria are used to extract one or more data items from the token stream or structure, where the extraction criteria are processed according to the organizing pattern to extract one or more tokens (or nodes from a layered structure). For position-based data, the token(s) at the position(s) identified by the extraction criteria are extracted. For attribute/value-based data, the token(s) and/or node(s) associated with the attribute(s) satisfying the extraction criteria are extracted. For hierarchical/layered data, the token(s) associated with the node(s) matching the extraction criteria are extracted. The extraction criteria may be as simple as an identifier string or may be a query presented to a structured data repository (where the data repository may be organized according to a database schema or data format, such as eXtensible Markup Language (XML)).

The extracted data may be used for further processing by the computing system. For example, the computing system (500) of FIG. 5A, while performing the one or more embodiments, may perform data comparison. Data comparison may be used to compare two or more data values (e.g., A, B). For example, one or more embodiments may determine whether A>B, A=B, A !=B, A<B, etc. The comparison may be performed by submitting A, B, and an opcode specifying an operation related to the comparison into an arithmetic logic unit (ALU) (i.e., circuitry that performs arithmetic and/or bitwise logical operations on the two data values). The ALU outputs the numerical result of the operation and/or one or more status flags related to the numerical result. For example, the status flags may indicate whether the numerical result is a positive number, a negative number, zero, etc. By selecting the proper opcode and then reading the numerical results and/or status flags, the comparison may be executed. For example, in order to determine if A>B, B may be subtracted from A (i.e., A—B), and the status flags may be read to determine if the result is positive (i.e., if A>B, then A−B>0). In one or more embodiments, B may be considered a threshold, and A is deemed to satisfy the threshold if A=B or if A>B, as determined using the ALU. In one or more embodiments, A and B may be vectors, and comparing A with B requires comparing the first element of vector A with the first element of vector B, the second element of vector A with the second element of vector B, etc. In one or more embodiments, if A and B are strings, the binary values of the strings may be compared.

The computing system (500) in FIG. 5A may implement and/or be connected to a data repository. For example, one type of data repository is a database. A database is a collection of information configured for ease of data retrieval, modification, re-organization, and deletion. Database Management System (DBMS) is a software application that provides an interface for users to define, create, query, update, or administer databases.

The user, or software application, may submit a statement or query into the DBMS. Then the DBMS interprets the statement. The statement may be a select statement to request information, update statement, create statement, delete statement, etc. Moreover, the statement may include parameters that specify data, data containers (a database, a table, a record, a column, a view, etc.), identifiers, conditions (comparison operators), functions (e.g. join, full join, count, average, etc.), sorts (e.g. ascending, descending), or others. The DBMS may execute the statement. For example, the DBMS may access a memory buffer, a reference or index a file for read, write, deletion, or any combination thereof, for responding to the statement. The DBMS may load the data from persistent or non-persistent storage and perform computations to respond to the query. The DBMS may return the result(s) to the user or software application.

The computing system (500) of FIG. 5A may include functionality to present raw and/or processed data, such as results of comparisons and other processing. For example, presenting data may be accomplished through various presenting methods. Specifically, data may be presented through a user interface provided by a computing device. The user interface may include a GUI that displays information on a display device, such as a computer monitor or a touchscreen on a handheld computer device. The GUI may include various GUI widgets that organize what data is shown as well as how data is presented to a user. Furthermore, the GUI may present data directly to the user, e.g., data presented as actual data values through text, or rendered by the computing device into a visual representation of the data, such as through visualizing a data model.

For example, a GUI may first obtain a notification from a software application requesting that a particular data object be presented within the GUI. Next, the GUI may determine a data object type associated with the particular data object, e.g., by obtaining data from a data attribute within the data object that identifies the data object type. Then, the GUI may determine any rules designated for displaying that data object type, e.g., rules specified by a software framework for a data object class or according to any local parameters defined by the GUI for presenting that data object type. Finally, the GUI may obtain data values from the particular data object and render a visual representation of the data values within a display device according to the designated rules for that data object type.

Data may also be presented through various audio methods. In particular, data may be rendered into an audio format and presented as sound through one or more speakers operably connected to a computing device.

Data may also be presented to a user through haptic methods. For example, haptic methods may include vibrations or other physical signals generated by the computing system. For example, data may be presented to a user using a vibration generated by a handheld computer device with a predefined duration and intensity of the vibration to communicate the data.

The above description of functions presents only a few examples of functions performed by the computing system (500) of FIG. 5A and the nodes (e.g., node X (522), node Y (524)) and/or client device (526) in FIG. 5B. Other functions may be performed using one or more embodiments.

While the one or more embodiments have been described with respect to a limited number of embodiments, those skilled in the art, having benefit of this disclosure, will appreciate that other embodiments can be devised which do not depart from the scope of the one or more embodiments as disclosed herein. Accordingly, the scope of the one or more embodiments should be limited only by the attached claims.

What is claimed is:

1. A method comprising:
receiving an event;
altering, responsive to receiving the event, a threshold pseudo-randomly to generate an altered threshold value;
applying the altered threshold value to a threshold-dependent feature to generate an altered threshold-dependent feature value, the altered threshold-dependent feature value determined at least in part from the event; and
executing a machine learning model, on the event and the altered threshold-dependent feature value, to generate a predicted event type for the event.

2. The method of claim 1,
wherein altering the threshold pseudo-randomly and applying the altered threshold value is performed for a plurality of threshold-dependent features to generate a plurality of altered threshold-dependent feature values, and
wherein the plurality of altered threshold-dependent feature values is used when executing the machine learning model.

3. The method of claim 2,
wherein altering the threshold pseudo-randomly and applying the altered threshold value is performed individually for the plurality of threshold-dependent features to generate a plurality of altered threshold values,
wherein at least two of the plurality of altered threshold values are different.

4. The method of claim 1, wherein the threshold-dependent feature comprises a lookback feature, and the threshold defines a length of a lookback period.

5. The method of claim 1, wherein the threshold-dependent feature comprises a number of occurrences of a plurality of past events satisfying a criterion for matching the event.

6. The method of claim 1, further comprising:
generating a hash value by hashing a timestamp of the event with a feature index of the threshold-dependent feature; and
altering the threshold-dependent feature using the hash value.

7. The method of claim 6, further comprising:
limiting the altered threshold value to be a corresponding range.

8. The method of claim 1, further comprising:
selecting the machine learning model from among a plurality of machine learning models, wherein the plurality of machine learning models each correspond to a distinct corresponding set of one or more altered threshold values,
the distinct corresponding set of one or more altered threshold values each altered pseudo-randomly.

9. The method of claim 8, wherein altering, responsive to receiving the event, the threshold pseudo-randomly to generate the altered threshold value comprises:
generating a pseudo-random number from information regarding the event; and
identifying the distinct corresponding set of one or more altered threshold values matching the pseudo-random number.

10. The method of claim 9, wherein generating the pseudo-random number comprises:
generating a hash of a timestamp of the event with an index of a selected feature of the plurality of threshold-dependent features.

11. The method of claim 1, wherein the predicted event type is selected from the group consisting of: a fraudulent login attempt, an authentic login attempt, a fraudulent monetary transfer, an authentic monetary transfer, a fraudulent use of software, and an authentic use of software.

12. The method of claim 1, further comprising:
storing a plurality of counts for the threshold-dependent feature in an array;
selecting, responsive to receiving the event and altering the threshold, a subset of the plurality of counts according to the altered threshold value to obtain a selected subset; and
aggregating, responsive to receiving the event and altering the threshold, the selected subset to generate the altered threshold-dependent feature value.

13. A method comprising:
obtaining a plurality of test events;
for each test event of the plurality of test events, individually creating at least one test case by:
altering a threshold pseudo-randomly to generate an altered threshold value,
applying the altered threshold value to a threshold-dependent feature to generate an altered threshold-dependent feature value, the altered threshold-dependent feature value determined at least in part from the plurality of test events, and
adding the threshold-dependent feature to a test case in the at least one test case; and
iteratively adjusting at least one machine learning model while executing the at least one machine learning model on the at least one test case of the plurality of test events to generate at least one trained machine learning model.

14. The method of claim 13, wherein the at least one machine learning model is a single machine learning model and the at least one test case is a single test case.

15. The method of claim 13, wherein the at least one machine learning model comprises a plurality of machine learning models, wherein each of the plurality of machine learning models comprises a distinct corresponding set of one or more altered threshold values.

16. The method of claim 15, wherein creating the at least one test case comprises individually creating a corresponding test case for each of the plurality of machine learning models according to the distinct corresponding set of one or more altered threshold values.

17. The method of claim 15, further comprising:
receiving a new event;
pseudo-randomly selecting a selected one of a first trained machine learning model and a second trained machine learning model of the at least one trained machine learning model; and
predicting, by the selected one of the first trained machine learning model and the second trained machine learning model, whether the new event matches a pre-determined event type.

18. A system comprising:
a server comprising a processor;
a data repository in communication with the server, the data repository storing:
an event having an event type, and
information regarding the event,
a machine learning model trained to classify the event, wherein the machine learning model is configured to receive as input the event and the plurality of altered threshold-dependent feature values; and
a server application configured, when executed by the processor, to:
generate the plurality of altered threshold-dependent feature values by altering, using the information regarding the event, a plurality of thresholds,
input, to the machine learning model, the event and the plurality of altered threshold-dependent feature values, and
generate, as output from the machine learning model, the predicted event type.

19. The system of claim 18, further comprising:
a fraud prevention application configured, when executed by the processor, to take an automatic security action responsive to the predicted event type corresponding to a fraudulent event type.

20. The system of claim 18, further comprising:
a training application configured to:
input a test case into the machine learning model,
generate a second plurality of altered threshold-dependent feature values by altering the plurality of thresholds,
input the second plurality of altered threshold-dependent feature values into the machine learning model,
output, from the machine learning model, a second predicted event type, generate a comparison by comparing the second predicted event type to an actual event type of the test case,
determine a loss function based on the comparison, and
iteratively adjusting the machine learning model using the loss function.
